(19) United States
(12) Patent Application Publication
(10) Pub. No.: US 2004/0019572 A1
(43) Pub. Date: Jan. 29, 2004

(54) Method and system for building digital markets

(76) Inventors: Carrie Metz, San Francisco, CA (US); Christopher Kuhn, West Chester, PA (US)

Correspondence Address: MORGAN LEWIS & BOCKIUS LLP, 1111 PENNSYLVANIA AVENUE NW, WASHINGTON, DC, 20004, US

(21) Appl. No.: 10/120,842

(22) Filed: Apr. 12, 2002

Related U.S. Application Data
(60) Provisional application No. 60/283,146, filed on Apr. 12, 2001.

(51) Int. Cl. G06F 17/60

(52) U.S. Cl. 705/80

(57) ABSTRACT

A system and method for using a multi-parametric marketplace during business-to-business commerce. The system includes an enterprise procurement platform, a collaborative commerce tool, multiple suppliers and multiple public and/or private business-to-business marketplaces. The enterprise procurement platform includes multiple business units, a contract manufacturer and a completion center. Data and business processes associated with the business units for supply chain partners are tightly integrated in the enterprise procurement platform. When buyers in the system select suppliers, the contract manufacturer creates contracts based on information obtained from trading partners and the completion center ensures that contract negotiations are completed and successfully awarded. The collaborative commerce tool includes multi-parametric mechanisms and it is available to all participants of the system to provide a competitive advantage to all trading partners by enabling efficient negotiations between a buyer and multiple suppliers. The system consolidates requirements among intra-enterprise and extra-enterprise suppliers to ensure consistency in providing procurement leverage to all participants in the system.

This application claims the benefit of U.S. Provisional Application No. 60/283,146 filed on Apr. 12, 2001.

### FIELD OF THE INVENTION

The present invention relates to a method and system for building digital markets and specifically, for offering a business-to-business electronic platform that provides buyers with a complete history of each vendor's performance and enables buyers to effectively negotiate with multiple suppliers.

### BACKGROUND OF THE INVENTION

Current electronic business-to-business activities are generally conducted in public or private electronic marketplaces. Private business-to-business marketplaces are usually owned and/or operated by large enterprises. Participants in private business-to-business marketplaces usually have integrated business processes and they usually strategically select trading partners. Generally, trading partners in private business-to-business marketplaces have long-term collaborative relationships, whereby commerce between trading partners is usually planned. Private business-to-business marketplaces also generally incorporate product design, collaborative forecasting, collaboration between participants based on specific demands and direct materials sourcing by the participants. However, in such environments, buyers do not usually receive the full advantage of their purchasing power in vendor negotiations because of their reliance on vendors who already participate in the marketplace. Buyers also may be exposed to risk due to over reliance on selected vendors. Trading partners also may miss opportunities to work with high performing vendors with whom they do not pre-existing relationships. Moreover, in these marketplaces, transactional cost are generally relatively high.

Public business-to-business marketplaces, on the other hand, are usually owned and/or operated by Internet market makers or consortium. Participants in public business-to-business marketplaces integrate their data instead of their business processes. Trading partners in these marketplaces are usually anonymous and/or unknown and their relationships are usually occasional and open. Additionally, commerce between the trading partners is usually opportunistic. For example, in order to purchase a product in a public business-to-business marketplace, a buyer must search for a suitable vendor and research products sold by each potentially suitable vendor. In such environments, since trading relationships are generally occasional and open, vendors may be required to carry undue levels of safety stock and they may also experience stock outs, which results in missed sales and/or poor service because the vendor is unresponsive to buyers' demands. Buyers, on the other hand, generally make needless compromises on quality and/or price. Transactional costs in public business-to-business marketplaces are also extremely high.

### SUMMARY OF THE INVENTION

The present invention relates to a system and method for using a multi-parametric marketplace during business-to-business commerce. The system includes an enterprise procurement platform, a collaborative commerce tool, multiple suppliers and multiple public and/or private business-to-business marketplaces. The enterprise procurement platform includes multiple business units, a contract manufacturer and a completion center. Data and business processes associated with the business units for supply chain partners are tightly integrated in the enterprise procurement platform. When buyers in the system select suppliers, the contract manufacturer creates contracts based on information obtained from trading partners and the completion center ensures that contract negotiations are completed and successfully awarded. The collaborative commerce tool includes multi-parametric mechanisms and it is available to all participants of the system to provide a competitive advantage to all trading partners by enabling efficient negotiations between a buyer and multiple suppliers. The system consolidates requirements among intra-enterprise and extra-enterprise suppliers to ensure consistency in providing procurement leverage to all participants in the system.

Additional features and advantages of the invention will be set forth in the description that follows, and in part will be apparent from the description, or may be learned by practice of the invention. The objectives and advantages of the invention will be realized and attained by the system and method particularly pointed out in the written description and claims hereof as well as the appended drawings.

To achieve these and other advantages and in accordance with the purpose of the invention, as embodied and broadly described, the present invention provides a system for building an electronic business-to-business marketplace with a platform that provides a buyer with a performance history for each supplier to enable effective negotiations between the buyer and multiple suppliers. The system comprises a procurement platform for tightly integrating data and business processes for suppliers, whereby the procurement platform creates contracts and enables contract negotiation between the buyer and a selected supplier; a collaboration tool comprising a plurality of parametric mechanisms that are available to all buyers and suppliers in the system to enable efficient negotiations between the buyer and a plurality of suppliers; and a plurality of participants in the system, whereby information from each of the plurality of participants is stored in the procurement platform and is used within the collaboration tool to affect selection of an appropriate supplier by the buyer.

An alternate embodiment of the invention provides a computer-readable medium whose contents cause a computer system to build an electronic business-to-business marketplace with a platform that provides a buyer with a performance history for each supplier to enable effective negotiations between the buyer and multiple suppliers. The computer-readable medium builds the marketplace by performing the steps of retrieving performance information from a procurement platform; rationalizing a master list with information retrieved from the procurement platform; creating a request for quotation with information from the master list; sending the request for quotation to a plurality of suppliers; managing the request for quotation and analyzing quotations received from the plurality of suppliers; and negotiating a contract between a selected supplier and a buyer and awarding the contract after successful negotiations.

The invention also provides a method for building an electronic business-to-business marketplace with a platform that provides a buyer with a performance history for each supplier to enable effective negotiations between the buyer and multiple suppliers, comprising retrieving performance information from a procurement platform; rationalizing a master list with information retrieved from the procurement platform; creating a request for quotation with information from the master list; sending the request for quotation to a plurality of suppliers; managing the request for quotation and analyzing quotations received from the plurality of suppliers; and negotiating a contract between a selected supplier and a buyer and awarding the contract after successful negotiations.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates the architecture of a multi-parametric marketplace;

FIG. 2 further illustrates the components of system 100; and

FIG. 3 illustrates the steps implemented in using system 100.

### DESCRIPTION OF THE PREFERRED EMBODIMENTS

Reference will now be made in detail to the preferred embodiments of the present invention, examples of which are illustrated in the accompanying drawings. The present invention described below extends the functionality of the inventive system and method for building digital business-to-business marketplaces with a platform that provides buyers with a complete history of intra and extra enterprise vendors' performances and enables the buyers to effectively negotiate with multiple suppliers.

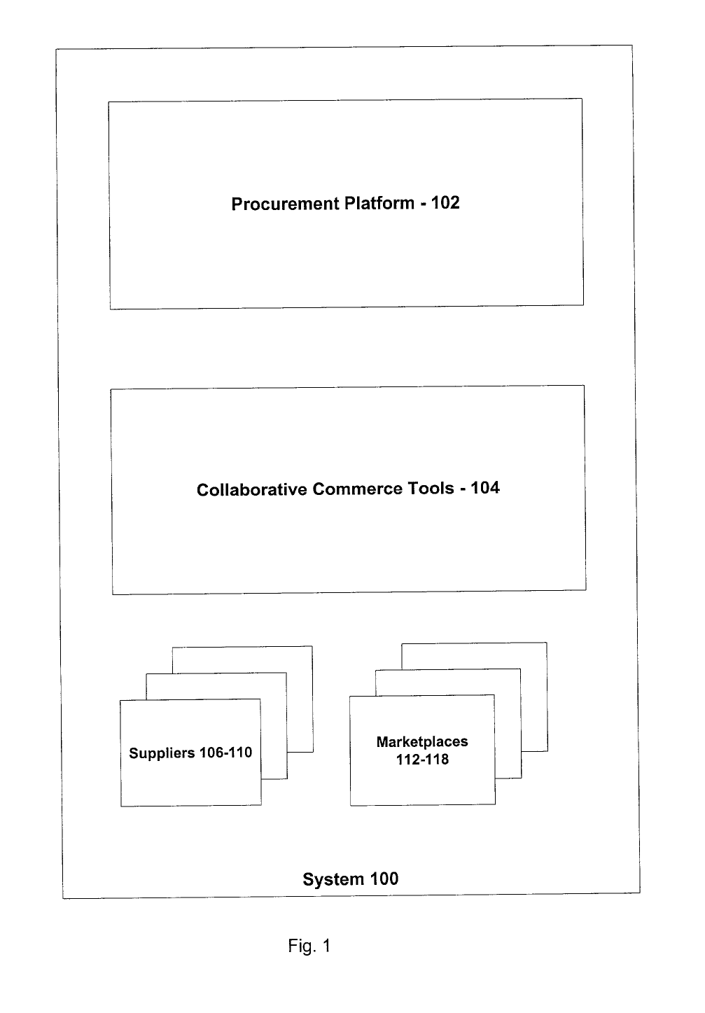

FIG. 1 illustrates the architecture of a multi-parametric marketplace system 100. System 100 includes an enterprise procurement platform 102, a collaborative commerce tool 104, multiple suppliers 106-110 and multiple marketplaces 112-118. Suppliers 106-110 may participate in system 100 through marketplaces 112-118 or they may participate in system 100 directly. Marketplaces 112-118 may be public or private business-to-business marketplaces, whereby participants of system 100 may be internal or external to an enterprise that owns or operates a private marketplace in system 100. In a preferred embodiment of the invention, system 100 consolidates requirements among intra-enterprise and extra-enterprise suppliers. This ensures consistency and provides procurement leverage to all participants in system 100. System 100 also provides a data integration platform for an extended enterprise of public and private business-to-business marketplaces and individual suppliers and it supports complex requirements of high-value direct material sourcing. Therefore, system 100 enables strategic sourcing to be performed for the extended enterprise rather than a single company or division.

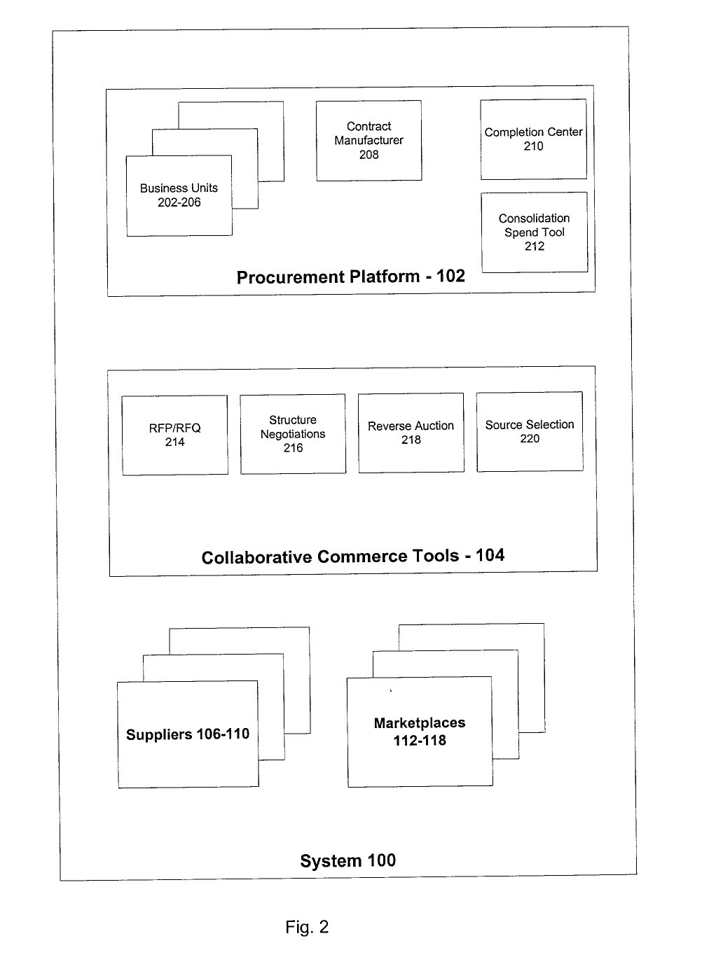

FIG. 2 further illustrates the components of system 100. Specifically, enterprise procurement platform 102 includes multiple business units 202-206, a contract manufacturer 208 and a completion center 210. Business processes for participants of system 100 may be associated with business units 202-206. Data and business processes for supply chain partners are tightly integrated in enterprise procurement platform 102. When buyers in system 100 select suppliers, contract manufacturer 208 creates contracts based on information obtained from trading partners and completion center 210 ensures that contract negotiations are completed and successfully awarded. Information from business units 202-206, contract manufacturer 208 and completion center 210 are stored in a consolidation spend tool 212. This provides broader input into demand and production forecasting, improves demand forecasts among supply chain partners, and reduces uncertainty and inventory carrying costs throughout the supply chain.

Collaborative commerce tool 104 includes multi-parametric mechanisms, such as request for price (RFP)/request for quotation (RFQ) 214, structured negotiations 216, reverse auction 218, and source-selection 220. The mechanisms of collaborative commerce tool 104 is available to all participants of system 100, provides a competitive advantage to all trading partners and enables efficient negotiations between a buyer and multiple suppliers. This enhances and sustains competition on product quality and price as well as on vendor service by using bidding and negotiation mechanisms to allocate supply among alternative supply chain partners based on availability and capacity. Collaborative commerce tool 104 also enables system 100 to dynamically allocate production to the most efficient trading partners and it provides targeted business process collaboration and not just transaction automation. Collaborative commerce tool 104 further enables targeted business process collaboration and not just transaction automation. Collaboration commerce tool 104 further supports the complex requirements associated with direct materials sourcing.

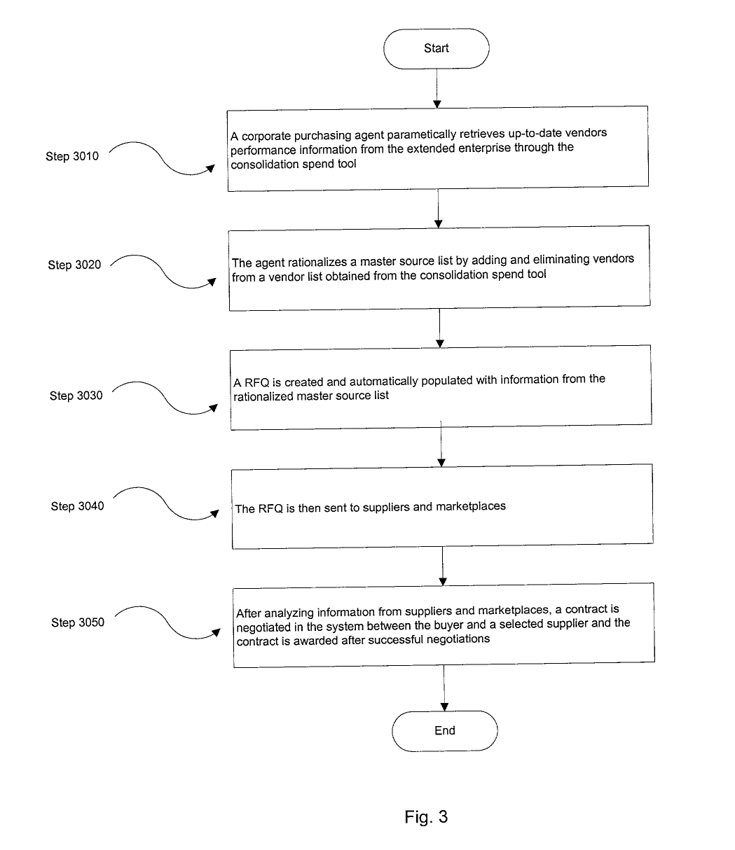

FIG. 3 illustrates the steps implemented in using system 100. In Step 3010, a corporate purchasing agent parametically retrieves up-to-date vendor performance information from the extended enterprise through consolidation spend tool 212. This information equips a strategic buyer with a complete view of the buyer's spending history and it provides complete information about each vendor in the extended enterprise performance. In Step 3020, the agent rationalizes a master source list by adding and eliminating vendors from a vendor list obtained from consolidation spend tool 212. In Step 3030, an RFQ is created and automatically populated with information from the rationalized master source list. In Step 3040, the RFQ is then sent to suppliers 106-110 and marketplaces 112-118. The RFQ is managed within the multi-parametric market environment and quotations from suppliers 106-110 and marketplaces 112-118 are analyzed in this integrated environment. The inventive system automates non-valued added activities, such as faxing and phoning around the RFQ process and provides tools that enable participants to respond intelligently and efficiently to emergencies. In Step 3050, after analyzing information from suppliers 106-110 and marketplaces 112-118, a contract is negotiated in system 100 between the buyer and a selected supplier and the contract is awarded after successful negotiations. System 100 therefore enables efficient negotiations between a buyer and multiple suppliers and it manages sourcing risks for participants in the business-to-business marketplace. The system also reduces the costs of direct materials and it improves responsiveness and flexibility and provides procurement velocity.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A system for building an electronic business-to-business marketplace with a platform that provides a buyer with a performance history for each supplier to enable effective negotiations between the buyer and multiple suppliers, the system comprising:
a procurement platform for tightly integrating data and business processes for suppliers, whereby the procurement platform creates contracts and enables contract negotiations between the buyer and a selected supplier;
a collaboration tool comprising a plurality of parametric mechanisms that are available to all buyers and suppliers in the system to enable efficient negotiations between the buyer and a plurality of suppliers; and
a plurality of participants in the system, whereby information from each of the plurality of participants is stored in the procurement platform and is used within the collaboration tool to affect selection of an appropriate supplier by the buyer.

2. The system of claim 1, wherein the procurement platform comprises a contract manufacturer for creating contracts when the buyer selects a plurality of suppliers.

3. The system of claim 1, wherein the procurement platform comprises a completion center for ensuring effective contract negotiations.

4. The system of claim 1, wherein the procurement platform comprises a consolidation spend tool for storing information from a plurality of units in the procurement platform.

5. The system of claim 1, wherein the parametric mechanisms comprises a request for price, a request for quotation, structured negotiations, reverse auctions and source selection.

6. The system of claim 5, wherein the collaboration tool enables the system to dynamically allocate production to the most efficient participants.

7. The system of claim 5, wherein the collaboration tool enables targeted business process collaboration.

8. The system of claim 1, wherein the plurality of suppliers participate in the system through a marketplace that is connected to the system.

9. The system of claim 8, wherein the marketplace is a public marketplace.

10. The system of claim 8, wherein the marketplace is a private marketplace.

11. The system of claim 1, wherein the system consolidates requirements among intra-enterprise and extra-enterprise suppliers.

12. A computer-readable medium whose contents cause a computer system to build an electronic business-to-business marketplace with a platform that provides a buyer with a performance history for each supplier to enable effective negotiations between the buyer and multiple suppliers, by performing the steps of:
retrieving performance information from a procurement platform;
rationalizing a master list with information retrieved from the procurement platform;
creating a request for quotation with information from the master list;
sending the request for quotation to a plurality of suppliers;
managing the request for quotation and analyzing quotations received from the plurality of suppliers; and
negotiating a contract between a selected supplier and a buyer and awarding the contract after successful negotiations.

13. The computer-readable medium of claim 12, wherein the step of retrieving further comprises the step of retrieving suppliers' performances information and spending history associated with a buyer.

14. The computer-readable medium of claim 12, wherein the step of sending the request for quotation further comprises the step of sending the request for quotation to a plurality of marketplaces.

15. The computer-readable medium of claim 12, wherein the step of managing further comprises the step of automating non-value activities around the request for quotation process.

16. The computer-readable medium of claim 12, wherein the step of managing further comprises the step of providing tools that enable participants to respond to emergencies.

17. A method for building an electronic business-to-business marketplace with a platform that provides a buyer with a performance history for each supplier to enable effective negotiations between the buyer and a plurality of suppliers, comprising:
retrieving performance information from a procurement platform;
rationalizing a master list with information retrieved from the procurement platform;
creating a request for quotation with information from the master list;
sending the request for quotation to a plurality of suppliers;
managing the request for quotation and analyzing quotations received from the plurality of suppliers; and
negotiating a contract between a selected supplier and a buyer and awarding the contract after successful negotiations.

18. The method of claim 17, wherein the step of retrieving further comprises the step of retrieving supplier performance information for each of the plurality of suppliers and spending history associated with a buyer.

19. The method of claim 17, wherein the step of sending the request for quotation further comprises the step of sending the request for quotation to a plurality of marketplaces.

20. The method of claim 17, wherein the step of managing further comprises the step of automating non-value activities around the request for quotation process.

21. The method of claim 17, wherein the step of managing further comprises the step of providing tools that enable participants to respond to emergencies.
